(19) United States
(12) Patent Application Publication
(10) Pub. No.: US 2007/0121609 A1
(43) Pub. Date: May 31, 2007

(54) Telephone system and hunting method of channel in the same

(75) Inventors: Kenichi Kitazawa, Hino-shi (JP); Shuichi Sato, Sagamihara-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/602,266

(22) Filed: Nov. 21, 2006

(30) Foreign Application Priority Data
Nov. 30, 2005 (JP) 2005-345967

(51) Int. Cl. H04L 12/66

(52) U.S. Cl. 370/356

(57) ABSTRACT

According to one embodiment, a telephone system includes a memory which stores a group table in which a plurality of groups divided and configured by using terminal IDs corresponding to the plurality of interface units are associated with interface units belonging to the groups, and a controller which refers to the group table when connection requests arrive from the IP networks or IP telephone terminals via the control channels and also when the communication channels are selected, preferentially selects idle communication channels in the group to which the control channels with the connection requests arrived thereat based on the reference result, and connects the IP networks or the IP telephone terminals that are request origins via the selected communication channels.

### CROSS-REFERENCE TO RELATED APPLICATIONS

This application is based upon and claims the benefit of priority from Japanese Patent Application No. 2005-345967, filed Nov. 30, 2005, the entire contents of which are incorporated herein by reference.

### BACKGROUND

1. Field

One embodiment of the invention relates to a telephone system and a hunting method of channels in the same for use in a system, such as an Internet protocol (IP) telephone system, which performs voice and video communications among telephone terminals via an IP network.

2. Description of the Related Art

In recent years, a network telephone system (IP telephone system, end point system) interactively transmitting/receiving images and voices as packet data in real time via IP network has begun to prevail.

The IP telephone system connects IP telephone terminals to the IP network and also connects the IP network to a general telephone network such as an analog telephone line or a public network via a gateway or a main apparatus. Further, the IP telephone system performs a protocol conversion and a format conversion, etc., of data by means of the IP telephone terminal or the gateway then enables voice communications among the mutual IP telephone terminals and among the IP telephone terminals and the general telephone network.

Meanwhile, in such type of system, the main apparatus having fixedly associated the IP telephone terminals with interface units each housing the IP telephone terminals, if there is no idle media channel for voices/videos in the interface units to be incoming call destinations, a caller has to follow a procedure to re-connect to other IP telephone terminal. Therefore, it takes huge amount of labor and times after the caller makes an outgoing call to an IP telephone terminal to be a connection destination until the caller becomes possible to a telephone call with the speaker at the IP telephone terminal to be the connection destination.

Therefore, a method has been proposed, in which a central control unit of the main apparatus monitors statuses of each media channel of each interface unit to receive incoming calls through idle media channels of the interface units (for instance, refer to Jpn. Pat. Appln. KOKAI Publication No. 2003-169079).

However, the aforementioned method always monitors the statuses of each media channel of a plurality of interface units to make the central control unit execute processes so as to receive incoming calls through the idle media channels in the same conditions. Therefore, the method cannot provide fine-tuned services corresponding to individual users.

Furthermore, in communications, control channels are fixedly associated with IP trunks and IP telephone terminals, respectively, and when media channels are changed at every connection call (at every call), some media channels have to go through firewalls or network address translation (NAT) routers, so that some measures are strongly desired.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic configuration view illustrating a communication system regarding a first embodiment of the present invention;

FIG. 2 is an exemplary block diagram illustrating a functional configuration of a main apparatus shown in FIG. 1;

FIG. 3 is an exemplary view illustrating one example of storage contents in a storage unit shown in FIG. 2;

FIG. 4 is an exemplary sequence view depicted to explain an example of grouping when private IP addresses are set to IP interface units in the first embodiment of the present invention;

FIG. 5 is an exemplary sequence view depicted to explain an example of grouping when private IP addresses and global IP addresses are set to IP interface units as a second embodiment of the present invention; and

FIG. 6 is an exemplary sequence view depicted to explain an example of grouping when global IP addresses are set to IP interface units as other embodiment of the present invention.

### DETAILED DESCRIPTION

Various embodiments according to the invention will be described hereinafter with reference to the accompanying drawings. In general, according to one embodiment of the invention, a telephone system equipped with a plurality of interface units each housing a plurality of communication channels, at least one of control channels making pairs with communication channels and one control channel, the plurality of communication channels to which Internet protocol (IP) networks and IP telephone terminals are connected, comprising: a memory which stores a group table in which a plurality of groups divided and configured by using terminal IDs corresponding to the plurality of interface units are associated with interface units belonging to the groups; and a controller which refers to the group table when connection requests arrive from the IP networks or IP telephone terminals via the control channels and also when the communication channels are selected, preferentially selects idle communication channels in the group to which the control channels with the connection requests arrived thereat based on the reference result, and connects the IP networks or the IP telephone terminals that are request origins via the selected communication channels.

### First Embodiment

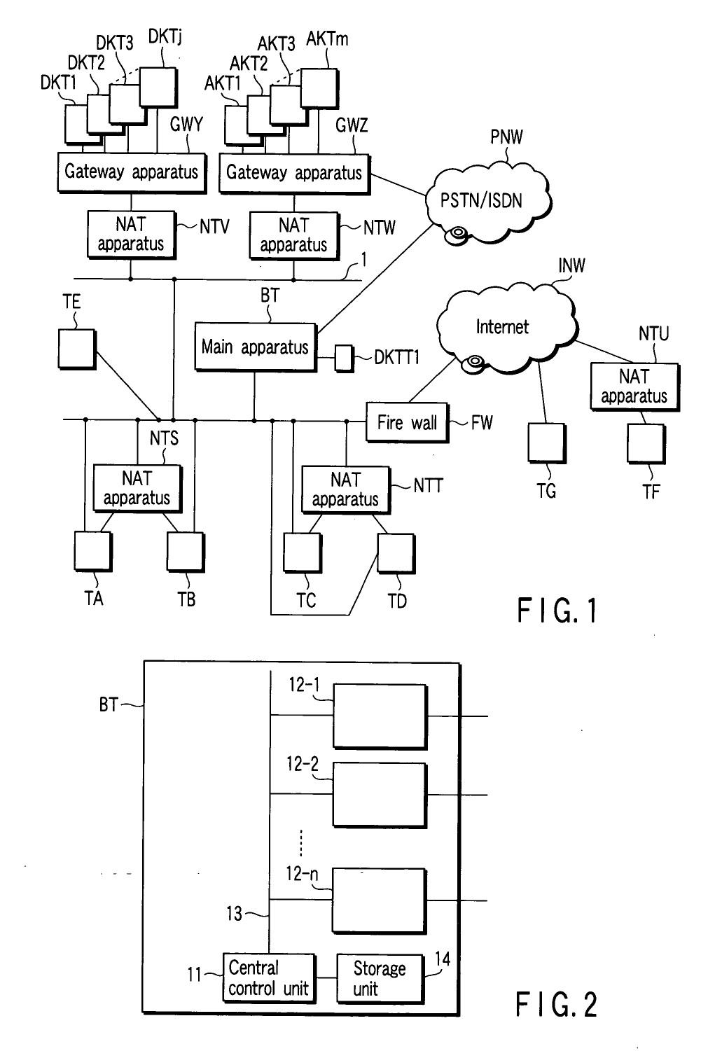

FIG. 1 is a schematic configuration view depicting a communication system regarding a first embodiment of the present invention.

The communication system has a local area network (LAN) 1. The LAN 1 connects a main apparatus (IP telephone system) BT, an IP telephone terminal TE, NAT apparatuses NTS, NTT, NTV, and NTW, and a firewall FW with one another. The NAT apparatus NTS has a conversion function of addresses among IP telephone terminals TA, TB and the LAN 1. The NAT apparatus NTT has a conversion function of addresses among IP telephone terminals TC, TD and the LAN 1.

A gateway apparatus GWY is connected to the NAT apparatus NTV, and a gateway apparatus GWZ is connected to the NAT apparatus NTW. A plurality of digital telephone sets DKT1-DKTj (j is natural number) are connected to the gateway apparatus GWY. A plurality of analog telephone sets AKT1-AKTm (m is natural number) and a public network PNW including a public switched telephone network (PSTN) and an integrated services digital network (ISDN) are connected to the gateway apparatus GWZ. The NAT apparatus NTV has a conversion function of addresses among the LAN 1 and the digital telephone sets DKT1-DKTj. The NAT apparatus NTW has a conversion function of addresses among the LAN 1 and the analog telephone sets AKT1-AKTm or the public network PNW.

The firewall FW connects between the LAN 1 and the internet INW. An IP telephone terminal TG and an NAT apparatus NTU are connected to the Internet INW. The NAT apparatus NTU has a conversion function of addresses between an IP telephone terminal TF and the Internet INW.

By the way, the main apparatus BT has the following functions as functions regarding the present invention.

FIG. 2 is a block diagram showing the configuration of the main apparatus BT.

The main apparatus BT has a central control unit 11, and IP interface units 12-1 to 12-n (n is natural number) as interface units other than interface units housing a conventional digital telephone set DKTT1, analog telephone sets AKT1-AKTm and office lines of the public network PNW. A central control unit 11 and IP interface units 12-1 to 12-n (n is natural number) are connected with one another via a bus 13.

The central control unit 11 arbitrarily interchanges and connects among mutual IP interface units 12-1 to 12-n to control voice signals/control signals among the IP interface units 12-1 to 12-n.

IP telephone terminals TA-TF, the NAT apparatuses NTS, NTT, NTV and NTW, and the firewall FW are connected to the IP interface units 12-1 to 12-n via media channels for voice/video communications of N channels, and via a control channel of N channels or one channel if necessary. The IP interface units 12-1 to 12-n conduct interface operations relating to the connected IP telephone terminals TA-TF, NAT apparatuses NTS, NTT, NTV and NTW, and firewall FW. Further, the IP interface units 12-1 to 12-n transmits and receives a variety of pieces of control information regarding the foregoing interface operations to and from the central control unit 11 via the bus 13.

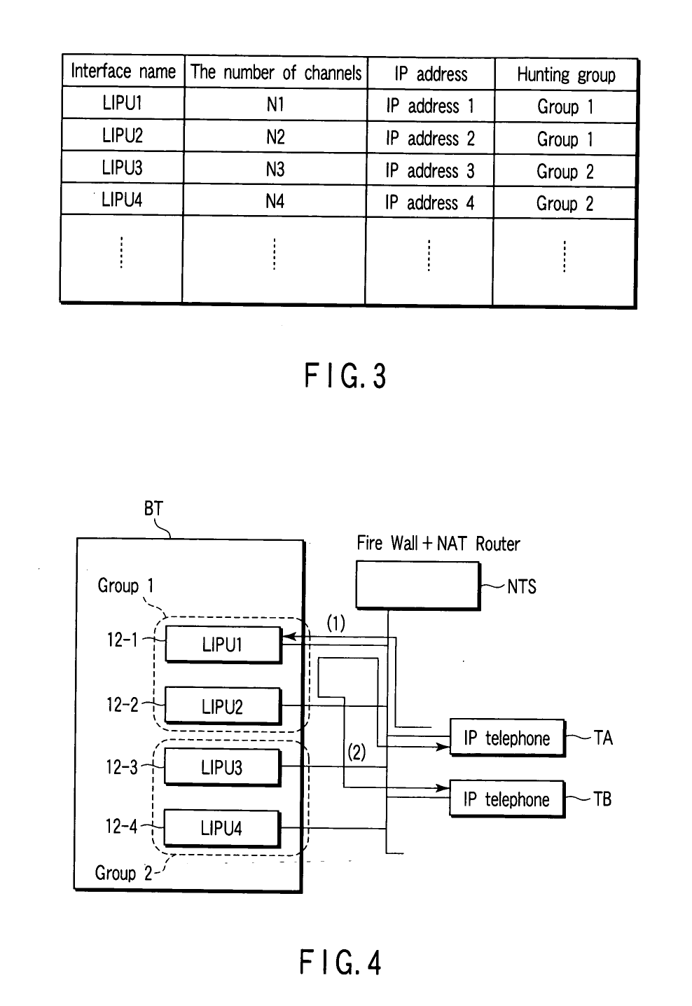

Meanwhile, a storage unit 14 is connected to the central control unit 11. The storage unit 14, as shown in FIG. 3, stores a group table showing relationships among hunting groups possible to select a plurality of media channels composed by dividing the IP interface units 12-1 to 12-n by using IP addresses as terminal IDs, IP addresses assigned to each IP interface unit 12-1 to 12-n belonging to the hunting groups, and the number of media channels housed in the IP interface units 12-1 to 12-n.

For instance, when an incoming call destined to the IP telephone terminal TB from the IP telephone terminal TA reaches via the control channel of the IP interface unit 12-1, the central control unit 11 refers to the group table stored in the storage unit 14 and connects the IP telephone terminals TA and TB to idle channels out of the media channels housed in the IP interface units 12-1 (LIPU1) and 12-2 (LIPU2) to establish a communication link between the IP telephone terminals TA and TB.

Next, operations in the configuration described above will be set forth.

(Registration Operation)

For example, when IP addresses 1, 2, 3 and 4 are set to the IP interface units 12-1 to 12-4, respectively, the central control unit 11 of the master device BT confirms whether the set terminal IDs (IP addresses) are global IP addresses or private IP addresses to automatically register the confirmation result in the group table of the storage unit 14. The classification among the global IP addresses and the private IP addresses is performed in the following method.
(1) FC 1918 recommends the following IP addresses as the global IP addresses.
   Class A: 10.X.X.X
   Class B: 172.16.X.X-172.31.X.X
   Class C: 192.168.X.X
(2) The classification of the private IP addresses are performed as the case in which other than the foregoing IP addresses are set.
(3) The classification of the global IP addresses and private addresses are registered in the same channel hunting group even if subnet masks are different from each other like addresses of 192.16.1.10 and 192.16.2.10.

The given classification having been an automatic registration, it is possible to manually register in the channel hunting groups in response to the IP addresses of each IP interface unit 12-1 to 12-4. It is also possible to divide the groups of the global IP addresses and the private IP addresses into a plurality of hunting groups, respectively, by distributing the channel hunting.

(Case in which Private Addresses are Set to IP Interface Units 12-1 to 12-4)

For instance, as shown in FIG. 4, it is presumed that the incoming call destined to the IP telephone terminal TB from the IP telephone terminal TA arrives at the IP interface unit 12-1 of the main apparatus BT. The central control unit 11 then determines that which hunting group of the media channels should be hunted from incoming data notified from the IP interface unit 12-1 based on the group table in the storage unit 14. The central control unit 11 hunts the idle media channels out of the IP interface units 12-1 and 12-2 belonging to the group 1 to form a communication link used the media channels.

Thus, a voice communication becomes possible between the IP telephone terminal TA and the IP telephone terminal TB to be the incoming call destination.

As described above, in the first embodiment, the main apparatus BT having stored the group table showing the correspondence relationships among a plurality of channel hunting groups and the IP interface units 12-1 to 12-4 in the storage unit 14, when the incoming call destined for the IP telephone terminal TB from the IP telephone terminal TA via the control channel, the central control unit 11 connects the IP telephone terminal TB to the IP telephone terminal TA that is a request origin via an idle media channel in a group 1, by referring to the group table stored in the storage unit 14. The central control unit 11 also connects the IP telephone terminal TA to the IP telephone terminal TB via the idle media channel in the group 1 by referring thereto.

Accordingly, the hunting of the media channel may be limited within the group 1, thereby; the connection destination can avoid waiting for a resource to an important IP telephone terminal TC.

In the first embodiment of the invention, the communication system can register the IP interface unit 12-5 through the manual operation of the user by associating with the channel hunting group in the group table, so that the communication system becomes possible to register only the really required IP interface unit 12-5 in the group table.

### Second Embodiment

FIG. 5 is a sequence view in the case in which the private IP addresses and the global IP addresses are set to the IP interface units 12-1 to 12-n, as a second embodiment of the present invention.

The group table in the storage unit 14 associates the IP interface units 12-1 and 12-2 with the private IP addresses set thereto with a group 1 to store them. The group table in the storage unit 14 associates the IP interface units 12-6 and 12-7 with the global IP addresses set thereto with a group 3 to also store them.

When dynamically using a channel resource, in the case of an IP trunk using a global IP address, the communication system can preferentially select and use the IP trunk from the channel resource of a hunting group 3. An also in the case of an IP telephone using a private IP address, the communication system can preferentially select and use the private IP address from the channel resource of a hunting group 1.

However, under the terms of hunting, either of the global IP addresses and the private IP addresses is available. When the IP interface units 12-6 and 12-7 for the IP trunk utilize the channels of the IP interface units 12-1 and 12-2 for the IP telephone (control channel of interface of global IP address utilizes media channel of private IP address), and when the IP interface units 12-1 and 12-2 for the IP telephone utilize the channels of the interface units 12-6 and 12-7 for the IP trunk (control channel of private IP address utilizes media channel of global IP address), the utilization goes over the NAT apparatus NTS, so that voice communications between END and END cannot be performed sometimes.

When the channel hunting becomes necessary to go over the NAT apparatus NTS, the problem described above is reduced due to restriction of the hunting of the channel resource depending on the channel hunting group.

To register a plurality of IP interface units 12-1 to 12-n to the channel hunting, a method for manually setting by an operator in advance and a method for automatically recognizing are possible approaches. In the case of manual setting, a maintenance person has to set the registration in response to the IP addresses.

The channel hunting, in the case in which, for example, the IP interface unit 12-8 has not been registered, utilizes the channel resource of the LIPUs of the IP interface units 12-1 to 12-n (utilizes media channels of IP interface units 12-1 to 12-n equivalent to control channel).

For instance, it is supposed that the incoming call addressed to the IP telephone terminal TA form the IP telephone terminal TE arrives at the IP interface unit 12-6 of the main apparatus BT. The central control unit 11 then determines that which hunting group of the media channels should be hunted among the items of the incoming call data notified from the IP interface unit 12-6 based on the group table in the storage unit 14. The central control unit 11 then hunts the idle media channels out of the IP interface units 12-6 and 12-7 belonging to the group 3 to connect the IP telephone terminal TE via the hunted media channels.

Next, the central control unit 11 hunts the idle media channels out of the IP interface units 12-1 and 12-2 belonging to the group 1 to connect the IP telephone terminal TA via the hunted media channel.

Thus, the voice communication becomes possible between the IP telephone terminal TE and the IP telephone terminal TA of the incoming call destination without going through the NAT apparatus NTS.

As mentioned above, in the second embodiment above given, the main apparatus BT stores the group table, associating the IP interface units 12-1 and 12-2 to each house the IP telephone terminals TA and TB with the private IP addresses assigned thereto with the group 1, and associating the IP interface units 12-6 and 12-7 to house the IP telephone terminal TE with the global IP address assigned thereto with the group 3, in the storage unit 14. Then, when the incoming call destined to the IP telephone terminal TA from the IP telephone terminal TE arrives at the IP interface unit 12-6, the central control unit 11 refers to the group table in the storage unit 14, connects the IP telephone terminal TE via the idle media channels of the IP interface units 12-6 and 12-7 belonging to the group 3 and also connects the IP telephone terminal TA to be the incoming call destination via the idle media channels of the IP interface units 12-1 and 12-2 belonging to the group 1. After this, the central control unit 11 connects between the IP interface unit 12-6 with the IP telephone terminal TE connected thereto and the IP interface unit 12-1 with the IP telephone terminal TA connected thereto.

Consequently, the hunting of such media channel, in which a communication inhibition caused by going through the NAT apparatus NTS occurs, may be avoided. The necessity of a transmission of a packet in a communication via the NAT apparatus NTS in order to determine the passing through of the NAT apparatus NTS to the IP interface units 12-1 to 12-n and a relay server is eliminated. Thereby, loads on the NAT apparatus NTS and the relay server may be reduced.

### Other Embodiment

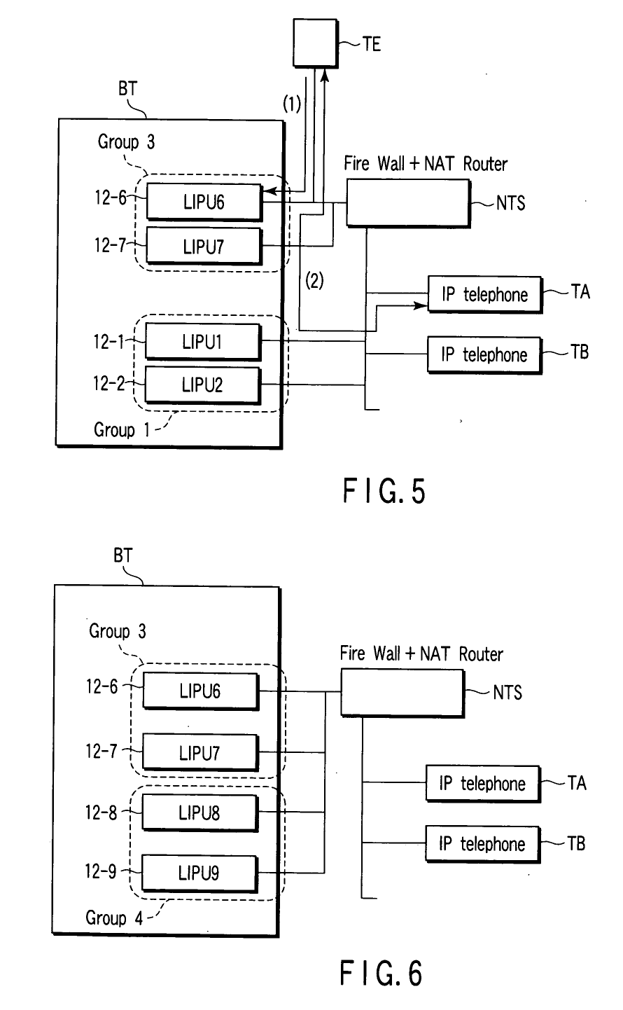

The present invention is not limited to the given each embodiment. In each embodiment, for instance, the examples are described, wherein the plurality of IP interface units with the private IP addresses set thereto are grouped, and the plurality of IP interface units with the private IP addresses set thereto and with the global IP addresses set thereto are individually grouped. However, the present invention is not limited to the examples, as shown in FIG. 6, the plurality of IP interface units 12-6 to 12-9 with the global IP addresses set thereto may be classified to the group 3 and 4, respectively.

In the aforementioned embodiments, having described about the examples grouping the plurality of IP interface units, it is acceptable to associate the identical segments with the identical channel hunting groups and register them when the media channel is divided and configured into a plurality of segments.

Other than this, various modifications of types and configurations of the telephone systems, configurations of the main apparatus, types of the IP telephone terminals such as telephone terminals, storage contents of the group tables, hunting control procedures of the media channels, and the like may be implemented within the rage not departing from the principle of the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone system equipped with a plurality of interface units each housing a plurality of communication channels, at least one of control channels making pairs with communication channels and one control channel, the plurality of communication channels to which Internet protocol (IP) networks and IP telephone terminals are connected, comprising:
a memory which stores a group table in which a plurality of groups divided and configured by using terminal IDs corresponding to the plurality of interface units are associated with interface units belonging to the groups; and
a controller which refers to the group table when connection requests arrive from the IP networks or IP telephone terminals via the control channels and also when the communication channels are selected, preferentially selects idle communication channels in the group to which the control channels with the connection requests arrived thereat based on the reference result, and connects the IP networks or the IP telephone terminals that are request origins via the selected communication channels.

2. The telephone system according to claim 1, when there are first interface units with first terminal IDs assigned thereto, there is a plurality of second interface units which stores the plurality of the first IP telephone terminals and the IP networks, respectively, to which second terminal IDs differing from the first terminal IDs are assigned among the plurality of the interface units, and the first and the second interface units are intermixed,
wherein, the memory stores a group table in which the plurality of the first interface units are associated with a first group when the first interface units are set to the first terminal IDs, and the plurality of the second interface units are associated with a second group when the second interface units are set to the second terminal IDs; and
the controller refers to the group table when connection requests destined to the second IP telephone terminals or the IP networks from the first IP telephone terminals, or connection requests destined to the first IP telephone terminals or the IP networks from the second IP telephone terminals are reach, connects the first IP telephone terminals via idle communication channels of the plurality of the first interface units belonging to the first group and also connects the second IP telephone terminals via idle communication channels of the plurality of the second interface units belonging to the second group based on the reference result, and after this, connects between the first interface units with the first IP telephone terminals connected thereto and the second interface units with the second IP telephone terminals connected thereto.

3. The telephone system according to claim 1, when the plurality of communication channels are divided and configured into a plurality of segments,
wherein, the memory stores a group table in which a plurality of communication channels belonging to the same segment are associated with the same group by using terminal IDs (IP addresses or subnet masks) set to the interface units.

4. The telephone system according to claim 2, further comprising: a recorder which records a group table by associating the plurality of the first interface units with the first group and by associating the plurality of the second interface units with the second group, when a storage instruction from a user is input.

5. The telephone system according to claim 3, further comprising: a recorder which records a group table by associating a plurality of interface units belonging to the same segment with the same group when a registration instruction from a user is input.

6. A hunting method of channels in a telephone system equipped with a plurality of interface units each housing a plurality of communication channels, at least one of control channels making pairs with communication channels and one control channel, the plurality of communication channels to which IP networks and IP telephone terminals are connected, comprising:
storing a group table in which a plurality of groups divided and configured by using terminal IDs corresponded to the plurality of interface units are associated with interface units belonging to the groups; and
referring to the group table when connection requests arrive from the IP telephone terminals via the control channels and also the communication channels are selected, preferentially selecting idle communication channels in the group to which the control channels with the connection requests arrived thereat based on the reference result, and connecting the IP networks or the IP telephone terminals that are request origins via the selected communication channels.
